(19) United States
(12) Patent Application Publication
(10) Pub. No.: US 2023/0110309 A1
(43) Pub. Date: Apr. 13, 2023

(54) TRANSACTION METHOD AND TRANSACTION APPARATUS

(71) Applicant: FUJITSU LIMITED, Kawasaki-shi (JP)

(72) Inventors: Toshihiro Shimizu, Kawasaki (JP); Akihito Nakamura, Shinagawa (JP); Akihiro Kuwabara, Meguro (JP); Motohiro Kosaki, Kawasaki (JP)

(73) Assignee: FUJITSU LIMITED, Kawasaki-shi (JP)

(21) Appl. No.: 17/860,197

(22) Filed: Jul. 8, 2022

(30) Foreign Application Priority Data
Oct. 13, 2021 (JP) 2021-168203

(51) Int. Cl. G06Q 10/08; G06Q 40/04

(52) U.S. Cl. CPC G06Q 10/087; G06Q 40/04

(57) ABSTRACT

A non-transitory computer-readable recording medium stores a program for causing a computer to execute a process, the process includes acquiring order information including at least a sell order count for each sell limit price, a buy order count for each buy limit price, a money amount designation sell order of designating a total amount of sell prices, and a money amount designation buy order of designating a total amount of buy prices, calculating, for each first/second price in sell/buy orders, a first/second contract-available count based on a sell/buy order count with the sell/buy limit price equal to or higher/lower than the first/second price and a quantity for selling/buying in the total amount designated by the money amount designation sell/buy order at the first/second price, and determining a contract price based on the calculated first and second contract-available counts for each price.

### CROSS-REFERENCE TO RELATED APPLICATION

This application is based upon and claims the benefit of priority of the prior Japanese Patent Application No. 2021-168203, filed on Oct. 13, 2021, the entire contents of which are incorporated herein by reference.

### FIELD

The embodiment discussed herein is related to a transaction method and a transaction apparatus.

### BACKGROUND

In transactions of stocks and the like in Japan, there are two types of transactions: Itayose and Zaraba. Itayose is a transaction in which orders accepted before trading is started are collected, trading for the collected orders is established, and an opening value is determined. Zaraba is a transaction in which trading is established between an already ordered order and a newly ordered order or between newly ordered orders.

For the transaction, board information (order information) indicating a sell limit price and a sell order count of a sell order and a buy limit price and a buy order count of a buy order is used. In Itayose of share transaction, based on the order information, a contract apparatus makes a contract regarding a sell order and a buy order in ascending order of the sell order and descending order of the buy order. When the sell order and the buy order have the same price, the contract apparatus stops the making of the contract, and sets the price at this time as a current value (contract price). After that, the contract apparatus moves to Zaraba, and establishes trading between the remaining orders included in the order information and the newly ordered order or between the newly ordered orders.

Japanese Laid-open Patent Publication No. 2002-366738 is disclosed as related art.

### SUMMARY

According to an aspect of the embodiment, a non-transitory computer-readable recording medium stores a program for causing a computer to execute a process, the process includes acquiring order information including at least a sell order count for each sell limit price, a buy order count for each buy limit price, a money amount designation sell order of designating a total amount of sell prices, and a money amount designation buy order of designating a total amount of buy prices, for a transaction target object, calculating, for each first price in sell orders, a first contract-available count based on a sell order count with the sell limit price equal to or higher than the first price and a quantity for selling in the total amount designated by the money amount designation sell order at the first price, calculating, for each second price in buy orders, a second contract-available count based on a buy order count with the buy limit price equal to or lower than the second price and a quantity for buying in the total amount designated by the money amount designation buy order at the second price, and determining a contract price based on the calculated first contract-available count for each price and the calculated second contract-available count for each price.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating a configuration example of a transaction system according to an embodiment;

FIG. 2 is a flowchart illustrating an operation example of a contract apparatus;

FIG. 3 is a diagram illustrating an example of order information;

FIG. 4 is a diagram illustrating matching of a contract-available count in buying and selling;

FIG. 5 is a diagram illustrating an incremental process;

FIG. 6 is a diagram illustrating a specific example of the incremental process;

FIG. 7 is a flowchart illustrating an example of the incremental process in a case of a sell order;

FIG. 8 is a flowchart illustrating an example of the incremental process in a case of a buy order; and

FIG. 9 is a diagram illustrating an example of a hardware configuration of a computer that implements the same functions as functions of the contract apparatus.

### DESCRIPTION OF EMBODIMENT

In the related art described above, there is a problem that, when a contract price is determined in Itayose, a money amount designation order for ordering buying and selling with the number of shares according to a share price in a transaction market, by designated money amount, is not reflected in the contract price.

Hereinafter, a transaction method and a transaction apparatus according to an embodiment will be described below with reference to the drawings. In the embodiment, configurations having the same functions will be denoted by the same reference signs, and redundant description thereof will be omitted. The transaction method and the transaction apparatus to be described in the embodiment below are merely examples, and are not intended to limit the embodiment.

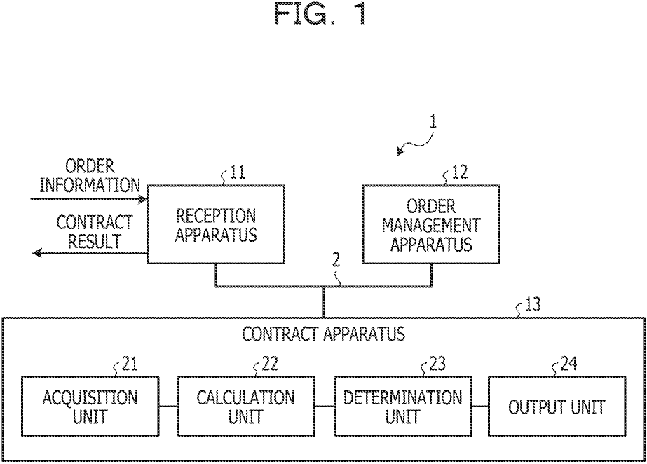

First, a configuration of a transaction system including a contract apparatus as an example of a transaction apparatus according to the present embodiment will be described. FIG. 1 is a diagram illustrating a configuration example of the transaction system according to the embodiment. As illustrated in FIG. 1, a transaction system 1 includes a reception apparatus 11, an order management apparatus 12, and a contract apparatus 13. The reception apparatus 11, the order management apparatus 12, and the contract apparatus 13 are coupled to each other via an internal network 2 such as a local area network (LAN).

The reception apparatus 11 accepts order information, and transmits the order information to the order management apparatus 12. For example, the order information includes an orderer identifier for identifying an orderer, a stock item, a distinction between buying and selling, a limit price, the number of shares, and the like.

As an example, this order information includes a limit price order in which an orderer identifier, a stock item, a distinction between buying and selling, a limit price (a buy limit price or a sell limit price), and the number of shares (a buy quantity or a sell quantity) are designated. The order information includes a market order for designating an orderer identifier, a stock item, a distinction between buying and selling, and the number of shares, and designating buying and selling of the number of shares in the market. The order information includes a money amount designation order for designating an orderer identifier, a stock item, a distinction between buying and selling, and a total amount of money for buying and selling, and designating buying and selling with the number of shares with which a transaction is available by the total amount.

Although a transaction target object in the transaction system 1 is a stock in the present embodiment, the transaction target object is not limited to the stock. For example, the transaction system 1 may be applied to a transaction market in which agricultural products, jewelry, and the like are transaction targets.

For example, the reception apparatus 11 receives order information transmitted from an information processing apparatus via an external network such as the Internet. For example, the information processing apparatus transmits the order information based on an order input by an investor using a mouse or a keyboard.

The reception apparatus 11 receives a contract result from the order management apparatus 12, and transmits the contract result to the information processing apparatus. For example, the contract result includes an orderer identifier, a stock item, a distinction between buying and selling, a contract price, the number of shares for a contract, and the like. For example, the reception apparatus 11 transmits the contract result to the information processing apparatus which is a transmission source of the order information by using an IP address associated with the orderer identifier.

The order management apparatus 12 manages the order information by adding an order identifier for identifying an order, for example. The order management apparatus 12 stores all pieces of order information accepted by the reception apparatus 11 before Itayose is started, and transmits the pieces of order information for each stock item to the contract apparatus 13 at a start of Itayose. For example, the order information includes a sell limit price and a sell order count, a buy limit price and a buy order count, the total amount of money for buying and selling corresponding to a money amount designation order, the number of shares (order count) for buying and selling corresponding to a market order, and the like for each stock item.

The order management apparatus 12 receives contract information for each stock item from the contract apparatus 13, and updates the order information. The order management apparatus 12 creates a contract result based on the contract information, and transmits the contract result to the reception apparatus 11. The contract information includes, for example, a sell limit price, a buy limit price, a contract price, the number of shares for a contract, and the like, for one or more contracts.

In Itayose, the contract apparatus 13 receives order information for each stock item from the order management apparatus 12 via the internal network 2, makes a contract regarding a sell order, a buy order, a money amount designation order, and a market order, and determines a contract price and a next share price. The contract apparatus 13 transmits contract information including the sell order, the buy order, the money amount designation order, and the market order for each stock item, regarding which a contract is made, and the determined contract price and next share price to the order management apparatus 12, via the internal network 2.

The contract apparatus 13 includes an acquisition unit 21, a calculation unit 22, a determination unit 23, and an output unit 24. The acquisition unit 21 acquires order information including a limit price order, a market order, and a money amount designation order related to buying and selling, for each stock item, from the order management apparatus 12 via the internal network 2.

Based on a sell order (the limit price order, the market order, and the money amount designation order) included in the acquired order information, the calculation unit 22 calculates, for each price (share price), a contract-available sell order count at this price (contract-available count). Based on a buy order (the limit price order, the market order, and the money amount designation order) included in the acquired order information, the calculation unit 22 calculates, for each price (share price), a contract-available buy order count at this price (contract-available count).

The determination unit 23 is a processing unit that determines a contract price, based on the contract-available count for each price in the sell order and the contract-available count for each price in the buy order, which are calculated by the calculation unit 22. For example, the determination unit 23 matches the contract-available count for each price in the sell order and the contract-available count for each price in the buy order, and sets a smaller one of the contract-available counts with each other as a contract count. The determination unit 23 determines a price that maximizes the contract count as a contract price.

For each stock item, the output unit 24 matches a sell order and a buy order included in the order information at the contract price determined by the determination unit 23 to obtain contract information. The output unit 24 transmits the contract information obtained for each stock item to the order management apparatus 12 via an internal network 2.

For example, the output unit 24 makes a contract regarding the market order, the money amount designation order, and the limit price order in the sell order and the buy order included in the order information by using the contract price as a reference, for each stock item. The output unit 24 generates, for example, contract information including a sell limit price, a buy limit price, a contract price, the number of shares for a contract, and the like, for one or more contracts as described above.

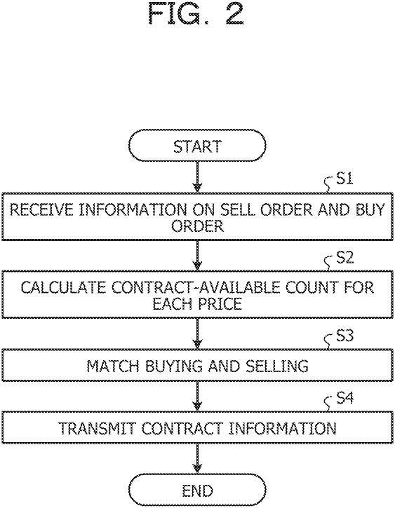

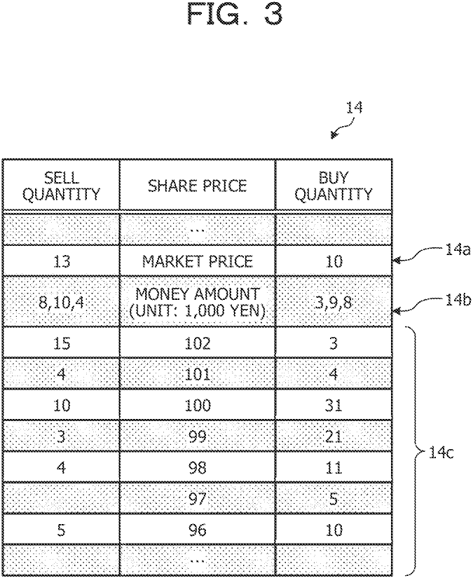

Next, a flow of a process by the contract apparatus 13 will be described. FIG. 2 is a flowchart illustrating an operation example of the contract apparatus 13. For each stock item, the contract apparatus 13 performs the process illustrated in FIG. 2. As illustrated in FIG. 2, the acquisition unit 21 of the contract apparatus 13 receives order information 14 (FIG. 3) on a sell order and a buy order from the order management apparatus 12 at a start of Itayose (S1).

FIG. 3 is a diagram illustrating an example of order information. As illustrated in FIG. 3, the order information 14 includes a market order 14a, a money amount designation order 14b, and a limit price order 14c.

The market order 14a is an order for designating a sell quantity or a buy quantity (both are the number of shares), and designating buying and selling in the market without designating a price (share price). In FIG. 3, for the market order 14a, there are an order for 13 shares for selling and an order for 10 shares for buying.

The money amount designation order 14b is an order for designating a total amount of money for buying and selling (in units of 1,000 yen in FIG. 3), and designating buying and selling with an order count corresponding to the total amount. In FIG. 3, for the money amount designation order 14b, there are orders of 8,000 yen, 10,000 yen, and 4,000 yen for selling, and there are orders of 3,000 yen, 9,000 yen, and 8,000 yen for buying.

The limit price order 14c is an order for designating a share price (a sell limit price or a buy limit price) and the number of shares for selling (a sell quantity) or the number of shares for buying (a buy quantity). In FIG. 3, there are sell orders of 15 shares for a sell limit price of 102 yen, 4 shares for a sell limit price of 101 yen, 10 shares for a sell limit price of 100 yen, 3 shares for a sell limit price of 99 yen, 4 shares for a sell limit price of 98 yen, and 5 shares for a sell limit price of 96 yen. There are buy orders of 3 shares for a buy limit price of 102 yen, 4 shares for a buy limit price of 101 yen, 31 shares for a buy limit price of 100 yen, 21 shares for a buy limit price of 99 yen, 11 shares for a buy limit price of 98 yen, 5 shares for a buy limit price of 97 yen, and 10 shares for a buy limit price of 96 yen.

Based on the orders (the limit price order, the market order, and the money amount designation order) included in the order information 14, the calculation unit 22 of the contract apparatus 13 calculates a contract-available count of the sell order and the buy order for each price (share price) (S2).

For example, based on the sell limit price order, the market order, and the money amount designation order included in the order information 14, the calculation unit 22 obtains a contract-available count for selling when a price is p as follows. [x] is a floor function representing a maximum integer equal to or smaller than x.

(sell count of market order) + (sell count of limit price order equal to or more than p yen) + ∑[total amount of money amount designation order/p]

Therefore, for example, a contract-available count for selling at the share price 100 in the order information 14 in FIG. 3 is as follows.
market order: 13
limit price order: 10 (100 yen) + 4 (101 yen) + 15 (102 yen) = 29
money amount designation order: 8,000/100 + 10,000/100 + 4,000/100 = 220
contract-available count = 13 + 29 + 220 = 262

In the same manner, based on the buy limit price order, the market order, and the money amount designation order included in the order information 14, the calculation unit 22 obtains a contract-available count for buying when a price is p as follows.

(buy count of market order) + (buy count of limit price order equal to or less than p yen) + Σ[total amount of money amount designation order/p]

Therefore, for example, a contract-available count for buying at the share price 100 in the order information 14 in FIG. 3 is as follows.
market order: 10
limit price order: 31 (100 yen) + 21 (99 yen) + 11 (98 yen) + 5 (97 yen) + 10 (96 yen) = 78
money amount designation order: 3,000/100 + 9,000/100 + 8,000/100 = 200
contract-available count = 10 + 78 + 200 = 288

After that, the determination unit 23 determines a contract price by matching buying and selling, for example, by matching a contract-available count for each price in the sell order and a contract-available count for each price in the buy order (S3). Based on the contract price determined in S3, the output unit 24 matches the sell order and the buy order included in the order information to obtain contract information. After that, the output unit 24 transmits the obtained contract information to the order management apparatus 12 via the internal network 2 (S4), and ends the process.

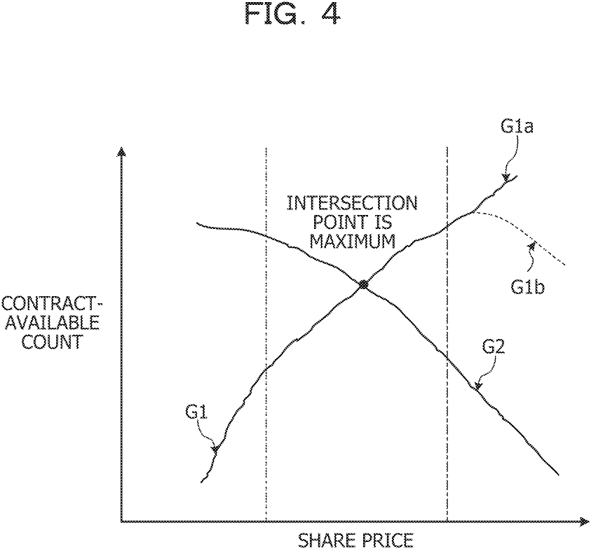

FIG. 4 is a diagram illustrating matching of a contract-available count in buying and selling. In FIG. 4, a horizontal axis indicates a share price and a vertical axis indicates a contract-available count. In FIG. 4, a graph G1 indicates a contract-available count for each share price for selling and a graph G2 indicates a contract-available count for each share price for buying.

As illustrated in FIG. 4, the determination unit 23 matches the graphs G1 and G2 with each other, sets a smaller count of contract-available counts as a contract count for each share price, and determines a point (intersection point of the graphs) at which the contract count is maximized as a contract price.

Although the graph G2 is monotonically decreased, the graph G1 is not monotonically increased, in some cases. For a sell order, an order count is commonly increased as a share price is higher, and thus the graph G1a is a monotonically increasing graph. Meanwhile, since a contract-available count is decreased as the share price is higher in a money amount designation order, the graph G1b which is not monotonically decreased may be obtained in a case where there are many money amount designation orders.

When calculating a contract-available count for each price, the calculation unit 22 may perform a process at high speed by calculating only a difference in updated portion in a case where the price is changed by a unit price (for example, 1 yen unit). In the following description, a process of calculating a contract-available count by changing a price by a unit price (for example, 1 yen unit) is referred to as an incremental process.

For example, in a case where a share price is changed from p yen to p+1 yen in the incremental process, an updated portion (difference) of a contract-available count related to a limit price order is an order count for p+1 yen. Therefore, in a case of obtaining a contract-available count in the incremental process, with respect to the contract-available count related to a limit price order, the calculation unit 22 may obtain the contract-available count by adding or subtracting the order count for changed price.

As for a contract-available count related to a money amount designation order, in a case where a share price is changed from p yen to p+1 yen in the incremental process, an order count for an order of x yen is changed from [x/p] to [x/(p+1)]. The calculation unit 22 disposes a flag (addition flag/subtraction flag) indicating an increase or decrease in the order count at the price at which the order count is numerically changed (an integer value is switched). In a case of obtaining a contract-available count in the incremental process, for the contract-available count related to the money amount designation order, the calculation unit 22 changes the contract-available count from the previous contract-available count when a price at which the flag is disposed is reached.

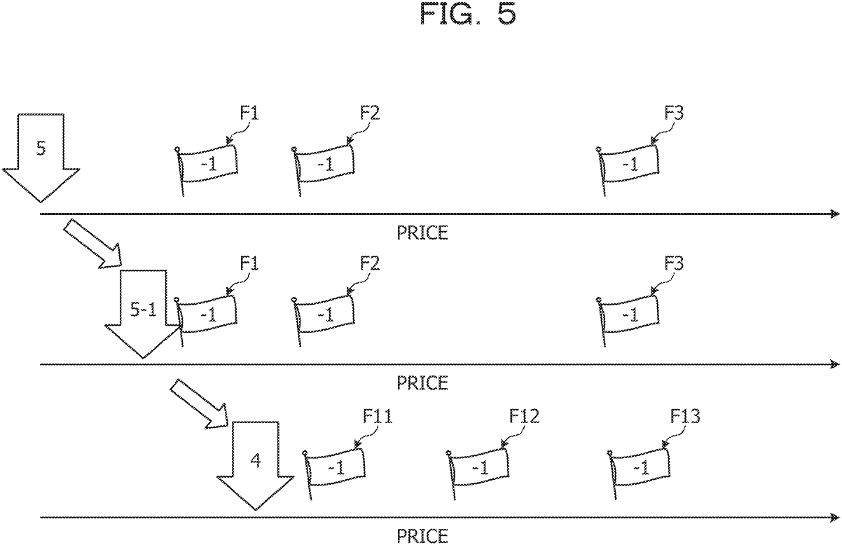

FIG. 5 is a diagram illustrating an incremental process. For example, FIG. 5 illustrates a case where a contract-available count related to a money amount designation order is calculated by an incremental process.

As illustrated in FIG. 5, the calculation unit 22 obtains a contract-available count (“5” in the example illustrated in FIG. 5) at a predetermined price (minimum share price) by the calculation method described above. Next, the calculation unit 22 sets subtraction flags F1 and F2 at prices at which an order count is switched (decreased) in a case where the incremental process is performed while the share price is increased from the minimum share price. In a case where the incremental process is performed while the price is decreased from the maximum share price, the calculation unit 22 sets an addition flag at a price at which the order count is switched (increased).

After that, when obtaining a contract-available count in the incremental process, the calculation unit 22 obtains the contract-available count related to a money amount designation order by subtraction from the previous count when a share price of a processing target reaches the subtraction flags F1 and F2. In FIG. 5, when a share price at which the subtraction flag F1 is set is reached, the calculation unit 22 subtracts 1 from 5, which is the previous contract-available count, and sets 4 to the contract-available count. After that, the calculation unit 22 resets the subtraction flags F11 and F12 at a price corresponding to the next subtraction.

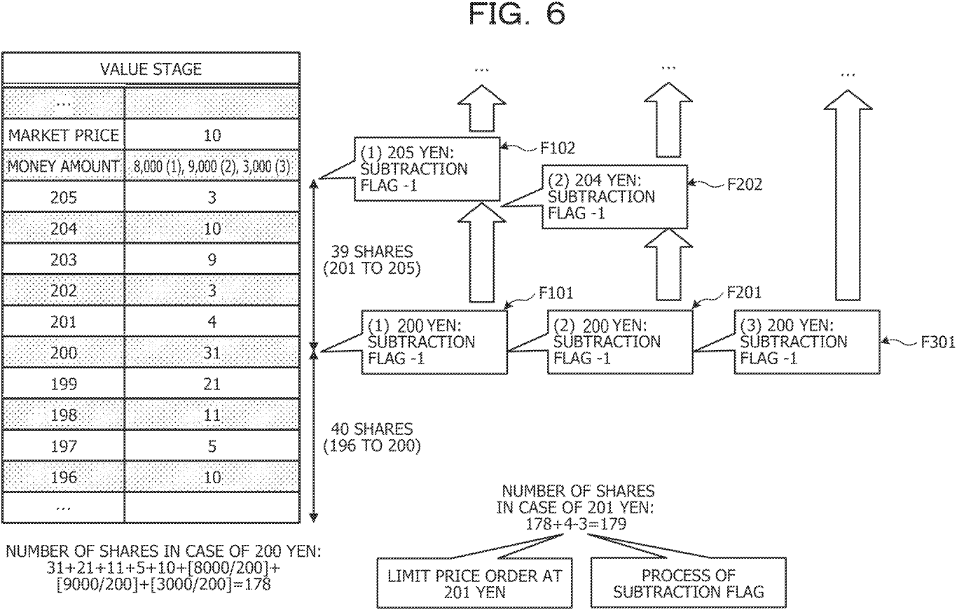

FIG. 6 is a diagram illustrating a specific example of an incremental process. A specific example in FIG. 6 illustrates a case where, for a sell order, a contract-available count is obtained by an incremental process of increasing a share price for each unit share price (1 yen) from a share price of 196 yen.

As illustrated in FIG. 6, for a money amount designation order (1) with a total amount of 8,000 yen, subtraction flags F101 and F102 are set when share prices are 200 yen and 205 yen. For a money amount designation order (2) with a total amount of 9,000 yen, subtraction flags F201 and F202 are set when share prices are 200 yen and 204 yen. For a money amount designation order (3) with a total amount of 3,000 yen, a subtraction flag F301 is set when a share price is 200 yen. It is assumed that a contract-available count in a case where the share price is 200 yen is 178 shares, and a contract-available count for the money amount designation order in the contract-available count is 100 shares.

When obtaining a contract-available count in the incremental process, in a case where the share price is changed from 200 yen to 201 yen, the calculation unit 22 adds 4 shares to the contract-available count since a limit price order count with the share price of 201 yen is “4”. Since the subtraction flags F101, F201, and F301 are set when the share price is 201 yen, the calculation unit 22 subtracts 3 shares from the previous number of shares. Therefore, the calculation unit 22 calculates 173 + 4 - 3, and sets 174 shares for the share price of 201 yen as the contract-available count.

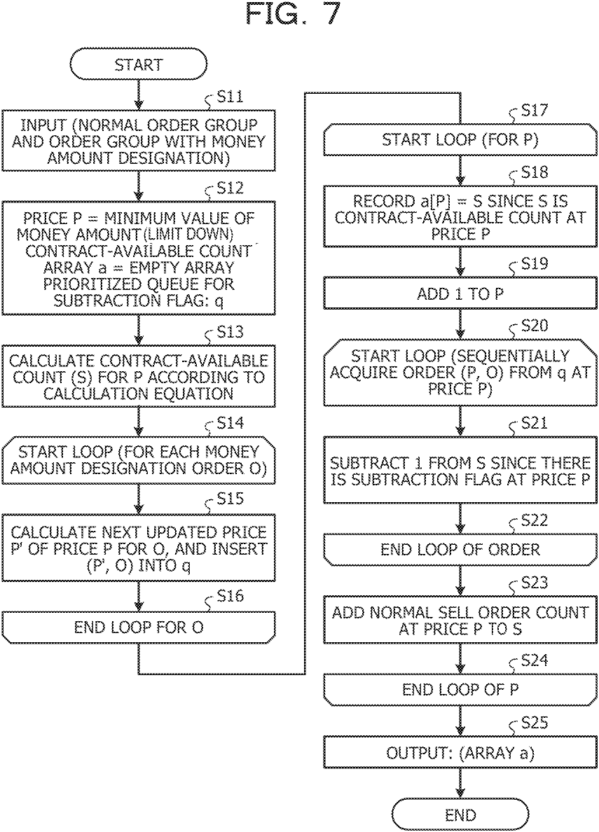

FIG. 7 is a flowchart illustrating an example of an incremental process in a case of a sell order.

As illustrated in FIG. 7, when a process is started, the acquisition unit 21 accepts an input of a normal sell order group (limit price order and market order) and a sell order group with money amount designation (money amount designation order) (S11).

After that, the calculation unit 22 sets a price P as a target of the incremental process to a minimum value (limit down) of a money amount. The calculation unit 22 sets an array a in which a contract-available count for selling is included, to an empty array. The calculation unit 22 secures a prioritized queue q for subtraction flag (S12).

After that, the calculation unit 22 calculates a contract-available count (S) for the price P (minimum amount) according to the calculation equation described above (S13), and executes a loop process for each money amount designation order O accepted in S11 (S14 to S16).

For example, in this loop process (S14 to S16), the calculation unit 22 calculates a price P′ to be obtained by updating the price P next for the money amount designation order O, and inserts (P′, O) into the queue q for subtraction flag (S15).

After the loop process (S14 to S16), the calculation unit 22 executes a loop process of obtaining a contract-available count for selling for each price P (S17 to S24).

For example, since the current S is a contract-available count at the price P, the calculation unit 22 records the array a [P] = S (S18). After that, the calculation unit 22 adds a unit price 1 to P (S19).

After that, the calculation unit 22 executes a loop process of sequentially acquiring an order (P, O) at the price P from the queue q for subtraction flag (S20 to S22). For example, a case where there is the order (P, O) at the price P in the queue q for subtraction flag means that there is a subtraction flag, and thus the calculation unit 22 subtracts 1 from the contract-available count S (S21).

After the loop process (S20 to S22), the calculation unit 22 adds a normal order count at the price P (limit price order count at the price P) to the contract-available count S (S23). After the loop process described above (S17 to S24), the calculation unit 22 outputs the obtained array a (S25), and ends the process.

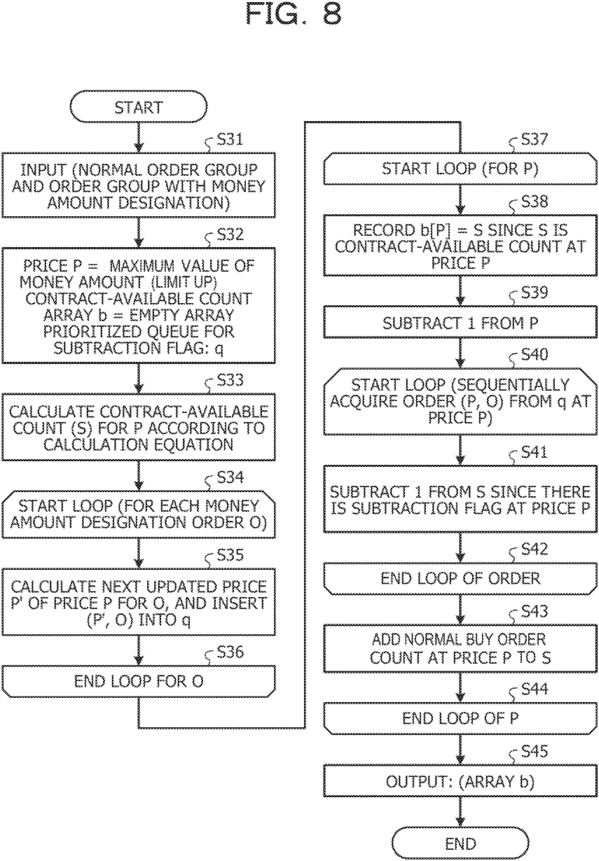

FIG. 8 is a flowchart illustrating an example of an incremental process in a case of a buy order.

As illustrated in FIG. 8, when a process is started, the acquisition unit 21 accepts an input of a normal buy order group (limit price order and market order) and a buy order group with money amount designation (money amount designation order) (S31).

After that, the calculation unit 22 sets the price P as a target of the incremental process as a maximum value (limit up) of a money amount. The calculation unit 22 sets an array b in which a contract-available count for buying is included, to an empty array. The calculation unit 22 secures the prioritized queue q for subtraction flag (S32).

After that, the calculation unit 22 calculates the contract-available count (S) for the price P (maximum amount) according to the calculation equation described above (S33), and executes a loop process for each money amount designation order O accepted in S11 (S34 to S36).

For example, in this loop process (S34 to S36), the calculation unit 22 calculates the price P′ to be obtained by updating the price P next for the money amount designation order O, and inserts (P′, O) into the queue q for subtraction flag (S35).

After the loop process (S34 to S36), the calculation unit 22 executes a loop process of obtaining a contract-available count for buying for each price P (S37 to S44).

For example, since the current S is a contract-available count at the price P, the calculation unit 22 records the array b [P] = S (S38). After that, the calculation unit 22 subtracts a unit price 1 from the price P (S39).

After that, the calculation unit 22 executes a loop process of sequentially acquiring an order (P, O) at the price P from the queue q for subtraction flag (S40 to S42). For example, a case where there is the order (P, O) at the price P in the queue q for subtraction flag means that there is a subtraction flag, and thus the calculation unit 22 subtracts 1 from the contract-available count S (S41).

After the loop process (S40 to S42), the calculation unit 22 adds a normal order count at the price P (limit price order count at the price P) to the contract-available count S (S43). After the loop process described above (S37 to S44), the calculation unit 22 outputs the obtained array b (S45), and ends the process.

As described above, the contract apparatus 13 acquires the order information 14 including at least a sell order count for each sell limit price, a buy order count for each buy limit price, a money amount designation sell order of designating the total amount of sell prices, and a money amount designation buy order of designating the total amount of buy prices, for a transaction target object. For each first price in a sell order, the contract apparatus 13 calculates a first contract-available count based on the sell order count with a sell limit price equal to or higher than the first price and a quantity for selling in the total amount designated by the money amount designation sell order at the first price. For each second price in a buy order, the contract apparatus 13 calculates a second contract-available count based on the buy order count with a buy limit price equal to or lower than the second price and a quantity for buying in the total amount designated by the money amount designation buy order at the second price. Based on the calculated first contract-available count and second contract-available count for each price, the contract apparatus 13 determines a contract price. Therefore, with the contract apparatus 13, it is possible to reflect the money amount designation order in the contract price in Itayose.

The contract apparatus 13 obtains a third price at which the quantity for selling by the money amount designation sell order is changed in a case where the first price is changed from a predetermined price. After that, the contract apparatus 13 changes the quantity for selling from the quantity at the previous price in a case where the third price is reached by changing the first price by a unit price from the predetermined price, to obtain a quantity for selling when calculating the first contract-available count. Therefore, when obtaining the quantity for selling in the total amount of money designated by the money amount designation order by changing the first price by a unit price from the predetermined price, the contract apparatus 13 may reduce the amount of calculation as compared with a case where a quantity for sequential selling is directly obtained.

The contract apparatus 13 obtains a fourth price at which the quantity for buying by the money amount designation buy order is changed in a case where the second price is changed from a predetermined price. After that, the contract apparatus 13 changes the quantity for buying from the quantity at the previous price in a case where the fourth price is reached by changing the second price by a unit price from the predetermined price, to obtain a quantity for buying when calculating the second contract-available count. Therefore, when obtaining the quantity for buying in the total amount designated by the money amount designation order by changing the first price by a unit price from the predetermined price, the contract apparatus 13 may reduce the amount of calculation as compared with a case where a quantity for sequential buying is directly obtained.

The order information 14 includes a market order for designating a sell order count or a buy order count without designating a sell limit price or a buy limit price. The contract apparatus 13 calculates a first contract-available count including the sell order count designated by the market order, and calculates a second contract-available count including the buy order count designated by the market order. Therefore, the contract apparatus 13 may determine a contract price in a case where the market order is included.

The transaction target object in the contract apparatus 13 is a stock. Therefore, the contract apparatus 13 may determine a contract price of a share price in the securities trading market.

Note that each component of each apparatus illustrated in the drawings may not be configured physically as illustrated in the drawings. For example, specific forms of the separation and integration of each apparatus are not limited to those illustrated in the drawings. The entirety or part of the apparatus may be configured by functionally or physically separating into arbitrary units or integrating into an arbitrary unit in accordance with various loads, usage situations, and the like.

All or certain some of the various processing functions of the acquisition unit 21, the calculation unit 22, the determination unit 23, and the output unit 24, to be performed in the contract apparatus 13, may be executed in a central processing unit (CPU) (or a microcomputer, such as a microprocessor unit (MPU) or a microcontroller unit (MCU)). All or certain some of the various processing functions may be executed on a program analyzed and executed by the CPU (or the microcomputer such as the MPU or the MCU) or may be executed on hardware using wired logic. The various processing functions performed in the contract apparatus 13 may be executed by a plurality of computers in cooperation with each other by cloud computing.

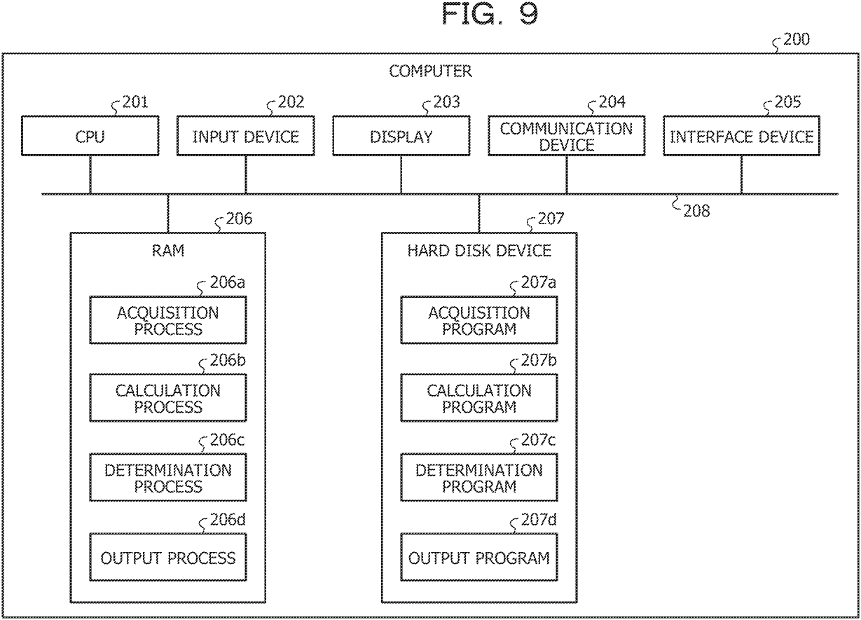

The various processes described in the embodiment described above may be implemented by the computer executing a program prepared in advance. Hereinafter, an example of a computer configuration (hardware) that executes the program having the same functions as in the embodiment described above will be described. FIG. 9 illustrates an example of a hardware configuration of a computer that implements the same functions as the functions of the contract apparatus 13.

As illustrated in FIG. 9, a computer 200 includes a CPU 201 as an example of a control unit that executes various operation processes such as an acquisition process 206a, a calculation process 206b, a determination process 206c, an output process 206d, and the like. The computer 200 includes an input device 202 which accepts an input of data from a user, and a display 203. The computer 200 includes a communication device 204 that receives data from an external apparatus, and an interface device 205 which is coupled to various apparatuses. The computer 200 includes a random-access memory (RAM) 206 that temporarily stores various types of information, and a hard disk device 207. Each of the CPU 201 to the hard disk device 207 is coupled to a bus 208.

The hard disk device 207 includes an acquisition program 207a, a calculation program 207b, a determination program 207c, and an output program 207d. The CPU 201 reads the acquisition program 207a, the calculation program 207b, the determination program 207c, and the output program 207d, and develops the programs into the RAM 206.

The acquisition program 207a functions as an acquisition process 206a. The calculation program 207b functions as a calculation process 206b. The determination program 207c functions as a determination process 206c. The output program 207d functions as an output process 206d.

A process of the acquisition process 206a corresponds to the process of the acquisition unit 21. A process of the calculation process 206b corresponds to the process of the calculation unit 22. A process of the determination process 206c corresponds to the process of the determination unit 23. A process of the output process 206d corresponds to the process of the output unit 24.

Each program of the acquisition program 207a, the calculation program 207b, the determination program 207c, and the output program 207d may not be stored in the hard disk device 207 from the beginning. For example, each program may be stored on a “portable physical medium” such as a flexible disk (FD), a compact disc read-only memory (CD-ROM), a Digital Versatile Disc (DVD), a magneto-optical disc, or an integrated circuit (IC) card to be inserted into the computer 200. Each program may be read and executed by the computer 200. Each program may be stored in a device coupled to a public network, the Internet, a LAN, or the like, and the computer 200 may read and execute each program from the device.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a program for causing a computer to execute a process, the process comprising:
acquiring order information including at least a sell order count for each sell limit price, a buy order count for each buy limit price, a money amount designation sell order of designating a total amount of sell prices, and a money amount designation buy order of designating a total amount of buy prices, for a transaction target object;
calculating, for each first price in sell orders, a first contract-available count based on a sell order count with the sell limit price equal to or higher than the first price and a quantity for selling in the total amount designated by the money amount designation sell order at the first price;
calculating, for each second price in buy orders, a second contract-available count based on a buy order count with the buy limit price equal to or lower than the second price and a quantity for buying in the total amount designated by the money amount designation buy order at the second price; and
determining a contract price based on the calculated first contract-available count for each price and the calculated second contract-available count for each price.

2. The non-transitory computer-readable recording medium according to claim 1, the process further comprising:
obtaining a third price at which the quantity for selling is changed in a case where the first price is changed from a predetermined price; and
changing the quantity for selling by the money amount designation sell order from a quantity at a previous price in a case where the third price is reached by repeatedly changing the first price by a unit price starting from the predetermined price.

3. The non-transitory computer-readable recording medium according to claim 1, the process further comprising:
obtaining a third price at which the quantity for buying is changed in a case where the second price is changed from a predetermined price; and
changing the quantity for buying by the money amount designation buy order from a quantity at a previous price in a case where the third price is reached by repeatedly changing the second price by a unit price starting from the predetermined price.

4. The non-transitory computer-readable recording medium according to claim 1, wherein
the order information includes a market order of designating the sell order count or the buy order count without designating the sell limit price or the buy limit price, and
the process further comprises:
calculating the first contract-available count by including the sell order count designated in the market order; and
calculating the second contract-available count by including the buy order count designated in the market order.

5. The non-transitory computer-readable recording medium according to claim 1, wherein
the transaction target object is a stock.

6. A transaction method, comprising:
acquiring, by a computer, order information including at least a sell order count for each sell limit price, a buy order count for each buy limit price, a money amount designation sell order of designating a total amount of sell prices, and a money amount designation buy order of designating a total amount of buy prices, for a transaction target object;
calculating, for each first price in sell orders, a first contract-available count based on a sell order count with the sell limit price equal to or higher than the first price and a quantity for selling in the total amount designated by the money amount designation sell order at the first price;
calculating, for each second price in buy orders, a second contract-available count based on a buy order count with the buy limit price equal to or lower than the second price and a quantity for buying in the total amount designated by the money amount designation buy order at the second price; and
determining a contract price based on the calculated first contract-available count for each price and the calculated second contract-available count for each price.

7. The transaction method according to claim 6, further comprising:
obtaining a third price at which the quantity for selling is changed in a case where the first price is changed from a predetermined price; and
changing the quantity for selling by the money amount designation sell order from a quantity at a previous price in a case where the third price is reached by repeatedly changing the first price by a unit price starting from the predetermined price.

8. The transaction method according to claim 6, further comprising:
obtaining a third price at which the quantity for buying is changed in a case where the second price is changed from a predetermined price; and
changing the quantity for buying by the money amount designation buy order from a quantity at a previous price in a case where the third price is reached by repeatedly changing the second price by a unit price starting from the predetermined price.

9. The transaction method according to claim 6, wherein
the order information includes a market order of designating the sell order count or the buy order count without designating the sell limit price or the buy limit price, and
the method further comprises:
calculating the first contract-available count by including the sell order count designated in the market order; and
calculating the second contract-available count by including the buy order count designated in the market order.

10. The transaction method according to claim 6, wherein
the transaction target object is a stock.

11. A transaction apparatus, comprising:
a memory; and
a processor coupled to the memory and the processor configured to:
acquire order information including at least a sell order count for each sell limit price, a buy order count for each buy limit price, a money amount designation sell order of designating a total amount of sell prices, and a money amount designation buy order of designating a total amount of buy prices, for a transaction target object;
calculate, for each first price in sell orders, a first contract-available count based on a sell order count with the sell limit price equal to or higher than the first price and a quantity for selling in the total amount designated by the money amount designation sell order at the first price;
calculate, for each second price in buy orders, a second contract-available count based on a buy order count with the buy limit price equal to or lower than the second price and a quantity for buying in the total amount designated by the money amount designation buy order at the second price; and
determine a contract price based on the calculated first contract-available count for each price and the calculated second contract-available count for each price.

12. The transaction apparatus according to claim 11, wherein
the processor is further configured to:
obtain a third price at which the quantity for selling is changed in a case where the first price is changed from a predetermined price; and
change the quantity for selling by the money amount designation sell order from a quantity at a previous price in a case where the third price is reached by repeatedly changing the first price by a unit price starting from the predetermined price.

13. The transaction apparatus according to claim 11, wherein
the processor is further configured to:
obtain a third price at which the quantity for buying is changed in a case where the second price is changed from a predetermined price; and
change the quantity for buying by the money amount designation buy order from a quantity at a previous price in a case where the third price is reached by repeatedly changing the second price by a unit price starting from the predetermined price.

14. The transaction apparatus according to claim 11, wherein
the order information includes a market order of designating the sell order count or the buy order count without designating the sell limit price or the buy limit price, and
the processor is further configured to:
calculate the first contract-available count by including the sell order count designated in the market order; and
calculate the second contract-available count by including the buy order count designated in the market order.

15. The transaction apparatus according to claim 11, wherein
the transaction target object is a stock.
